(19) United States
(12) Patent Application Publication
(10) Pub. No.: US 2022/0308389 A1
(43) Pub. Date: Sep. 29, 2022

(54) DISPLAY MODULE, METHOD FOR MANUFACTURING THE SAME AND DISPLAY DEVICE

(71) Applicants: Beijing BOE Display Technology Co., Ltd., Beijing (CN); BOE Technology Group Co., Ltd., Beijing (CN)

(72) Inventors: Zhuang XU, Beijing (CN); Xiaodi SUN, Beijing (CN); Jixing SUN, Beijing (CN)

(21) Appl. No.: 17/574,398

(22) Filed: Jan. 12, 2022

(30) Foreign Application Priority Data
Mar. 23, 2021 (CN) 202120589030.6

(51) Int. Cl. G02F 1/1335; G02F 1/1333

(52) U.S. Cl. CPC G02F 1/133512; G02F 1/13332; G02F 1/133504; G02F 1/133314; G02F 2202/28

(57) ABSTRACT

Provided are a display module, a method for manufacturing the same, and a display device. The display module includes a display panel, an optical film disposed on a backlight side of the display panel, a support assembly configured to support the display panel and the optical film, and a light shielding structure disposed on a side surface of the optical film.

### CROSS-REFERENCE TO RELATED APPLICATION

This application is based on and claims priority to Chinese Patent Application No. 202120589030.6, filed Mar. 23, 2021 and entitled “DISPLAY PANEL,” the disclosure of which is herein incorporated by reference in its entirety.

### TECHNICAL FIELD

The present disclosure relates to a display module, a method for manufacturing the same, and a display device.

### BACKGROUND

With the development of display technologies, an increasingly high requirement is imposed on image quality on the periphery of a display device. For enhancement of the image quality on the periphery of the display device, it is critical to ensure that no bright edge or no light leakage occurs on the periphery of the display device.

### SUMMARY

Embodiments of the present disclosure provide a display module, a method for manufacturing the same, and a display device.

In a first aspect of the embodiments of the present disclosure, a display module is provided. The display module includes: a display panel; an optical film, disposed on the backlight side of the display panel; a support assembly, configured to support the display panel and the optical film; and a light shielding structure, disposed on a side surface of the optical film.

In some embodiments, the light shielding structure includes at least one of: a light shielding film coated on a side surface of the optical film; and a light shielding block attached to the side surface of the optical film.

In some embodiments, a material of the light shielding structure includes a black resin.

In some embodiments, the side surface of the optical film includes a target side surface and a non-target side surface, wherein the target side surface is disposed on a bonding side of the display panel, the non-target side surface is a side surface other than the target side surface, and the light shielding structure is disposed on the non-target side surface.

In some embodiments, the support assembly includes a first support stage and a second support stage that are stepwise distributed; wherein with respect to the display panel, the optical film, the first support stage, and the second support stage:

both the display panel and the optical film are disposed on the first support stage; or

the display panel is disposed on the first support stage and the optical film is disposed on the second support stage.

In some embodiments, the display module further includes: a diffuser plate, disposed on a side, distal from the display panel, of the optical film.

In some embodiments, the diffuser plate is fixed to the second support stage by a double-sided adhesive tape.

In some embodiments, the support assembly includes: a front frame and a middle frame; wherein the middle frame includes the first support stage and the second support stage; and the front frame includes a body portion of the front frame and a bend portion of the front frame connected to the body portion of the front frame, wherein the body portion of the front frame is disposed on a side of the display panel, the bend portion of the front frame is disposed on a side of a display surface of the display panel, and the body portion of the front frame is connected to the middle frame.

In some embodiments, a foam rubber layer is disposed between the bend portion of the front frame and the display panel, wherein a free thickness of the foam rubber layer is less than a predetermined thickness, the free thickness of the foam rubber layer is a thickness of the foam rubber layer in an uncompressed state, and a thickness direction of the foam rubber layer is perpendicular to a display surface of the display panel.

In some embodiments, the support assembly further includes a back plate; wherein the back plate includes a body portion of the back plate and a bend portion of the back plate connected to the body portion of the back plate, wherein the body portion of the back plate is disposed on a side, distal from the display panel, of the optical film, the bend portion of the back plate is disposed on a side, distal from the body portion of the front frame, of the middle frame and is connected to the middle frame.

In some embodiments, each of the front frame, the middle frame, and the back plate is an integrally formed structure; and the front frame, the middle frame, and the back plate are fixedly connected.

In some embodiments, the display panel includes a liquid crystal display panel.

In some embodiments, the display module is a splicing screen, wherein a splicing seam is present in the splicing screen, and the light shielding structure is disposed on a side, distal from the splicing seam, of the splicing screen.

In a second aspect of the embodiments of the present disclosure, a method for manufacturing a display module is provided. The method includes: manufacturing a display panel and an optical film; forming a light shielding structure on a side of the optical film; and disposing the display panel and the optical film on a support assembly, wherein the optical film is disposed on a backlight side of the display panel, such that the display module is obtained.

In some embodiments, forming the light shielding structure on the side surface of the optical film includes at least one of: forming a light shielding film on the side surface of the optical film by coating; and forming a light shielding block on the side surface of the optical film by attaching.

In some embodiments, the support assembly includes a first support stage and a second support stage that are stepwise distributed; and disposing the display panel and the optical film on the support assembly includes: disposing the display panel and the optical film on the first support stage; or disposing the display panel on the first support stage and disposing the optical film on the second support stage.

In some embodiments, the method further includes: fabricating a diffuser plate; and disposing the diffuser plate on the support assembly, such that the diffuser plate is disposed on a side, distal from the display panel, of the optical film.

In some embodiments, disposing the diffuser plate on the support assembly includes: fixing the diffuser plate to the second support stage by a double-sided adhesive tape.

In a third aspect of the embodiments of the present disclosure, a display device is provided. The display device includes a display module as provided in the first aspect or in any of the alternative implementations of the first aspect.

### BRIEF DESCRIPTION OF THE DRAWINGS

FIG. 1 is a schematic structural diagram of a display module in the related art;

FIG. 2 is a schematic structural diagram of another display module in the related art;

FIG. 3 is a schematic structural diagram of a display module according to an embodiment of the present disclosure;

FIG. 4 is an enlarged view of area A in FIG. 3;

FIG. 5 is a schematic diagram of a light path of a display module according to an embodiment of the present disclosure;

FIG. 6 is a schematic structural diagram of another display module provided according to an embodiment of the present disclosure;

FIG. 7 is a schematic structural diagram of still another display module according to an embodiment of the present disclosure; and

FIG. 8 is a flowchart of a method for manufacturing a display module according to an embodiment of the present disclosure.

### DETAILED DESCRIPTION

The present disclosure will be further described in detail below in conjunction with specific embodiments and with reference to the accompanying drawings.

In the embodiments of the present disclosure, unless otherwise defined, the technical or scientific terms used in the present disclosure should be given the ordinary meanings as understood by those with ordinary skill in the art to which this disclosure belongs. The terms “first,” “second,” and the like used in the present disclosure do not indicate any order, quantity or importance, but are only used to distinguish different components. The terms “include,” “comprise,” and variations thereof mean that the element or item appearing in front of the word covers the element or item listed behind the word and its equivalents, but does not exclude other elements or items. The terms “coupled,” “connected,” and the like are not to be limited to physical or mechanical connections, but can include electrical connections, whether direct or indirect. The terms “up,” “down,” and the like are only used to indicate the relative position relationship. In the case that the absolute position of the described object changes, the relative position relationship may also change accordingly.

With the development of super large format display (SLFD) technology, an increasingly high requirement is imposed on image quality on the periphery of a display device. For enhancement of the image quality on the periphery of the display device, it is critical to ensure that no bright edge or no light leakage occurs on the periphery of the display device. The display device includes a display module, and bright edge occurs in the currently mass-produced display modules, or, although some solutions can address the bright edge of the display module, the cost of solving the technical problem is relatively high. For example, the material cost and the assembly cost are both high.

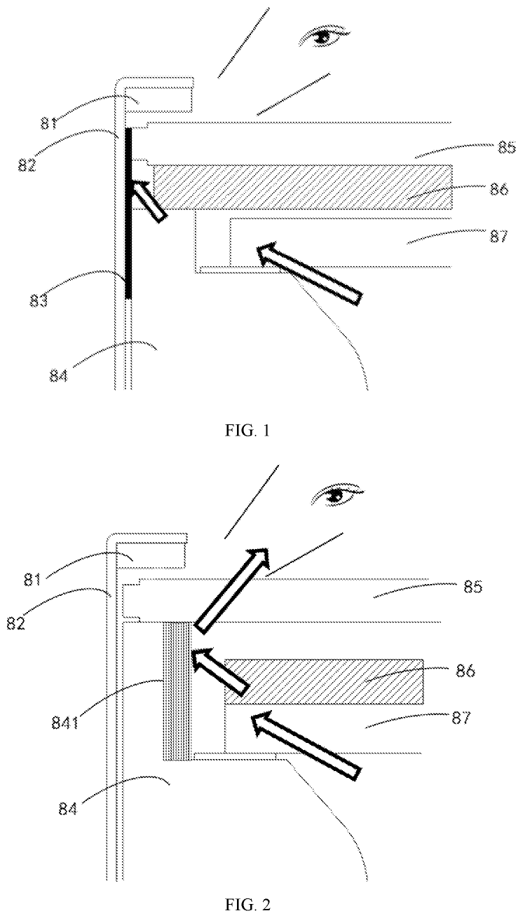

FIG. 1 is a schematic structural diagram of a display module provided according to the related art. The display module includes a display panel 85, an optical film 86, a diffuser plate 87, a bezel 82, a middle frame 84, a foam 81, and a rubber ribbon 83. The display panel 85, the optical film 86, and the diffuser plate 87 are overlapped on the middle frame 84, the optical film 86 and the diffuser plate 87 are disposed on the backlight side of the display panel 85, the bezel 82 is disposed on the exterior side surface of the middle frame 84, the rubber ribbon 83 is attached to the interior side surface of the bezel 82, the rubber ribbon 83 extends from the gap between the bezel 82 and the display panel 85 to the gap between the bezel 82 and the middle frame 84, the foam 81 is disposed in the gap between the bezel 82 and the edge of the display panel 85, and the foam 81 is thick. Light emitted from the backlight (not shown in FIG. 1) enters the optical film 86 through the diffuser plate 87, and a part of the light emitted into the optical film 86 is transmitted from the side surface of the optical film 86. If no rubber ribbon 83 and foam 81 are provided, light transmitted from the side surface of the optical film 86 is transmitted from the display module through the gap between the bezel 82 and the display panel 85, thereby causing a bright edge of the display module. In the display module shown in FIG. 1, the rubber ribbon 83 and the foam 81 may block the light transmitted from the side surface of the optical film 86, preventing the light transmitted from the side surface of the optical film 86 from being emitted from the display module. Therefore, the bright edge of the display module is addressed.

However, the display module shown in FIG. 1 needs to be attached with the rubber ribbon 83 and use the thick foam 81. In one aspect, the material cost and the labor cost may increase, and in the other aspect, the rubber ribbon 83 may pull the display panel 85 and the risk of squeezing and light leakage may be present. Thereafter, the high temperature generated by structural work such as the display panel can easily cause the middle frame 84 to expand and squeeze the bezel 82, such that the bezel 82 may evert, and the shielding effect of the bezel 82 becomes worse. The gap between the bezel 82 and the display panel 85 is likely to be light leakage again.

FIG. 2 is a schematic structural diagram of another display module provided according to the related art. In the display module, both the optical film 86 and the diffuser plate 87 are disposed on a side, distal from the bezel 82, of the side wall 841 of the middle frame, wherein the light transmitted from the side surface of the optical film 86 can be reflected from the side wall 841 of the middle frame, such that the light transmitted from the side surface of the optical film 86 can be prevented from being transmitted from the display module through the gap between the bezel 82 and the display panel 85. Therefore, the bright edge of the display module is addressed. However, the side wall 841 of the middle frame may reflect the light transmitted from the side of the optical film 86 to the active area (AA) of the display panel 85. Therefore, the display effect of the AA of the display panel 85 may be easily affected.

Embodiments of the present disclosure provide a display module, a method for manufacturing the same and a display device. In the display module, a light shielding structure is disposed on the side surface of the optical film, wherein the light shielding structure may block light, and the light inside the optical film may be prevented from being transmitted from the side surface of the optical film. Therefore, the bright edge of the display module is addressed.

The technical solutions of the present disclosure are described in further detail below in conjunction with the accompanying drawings.

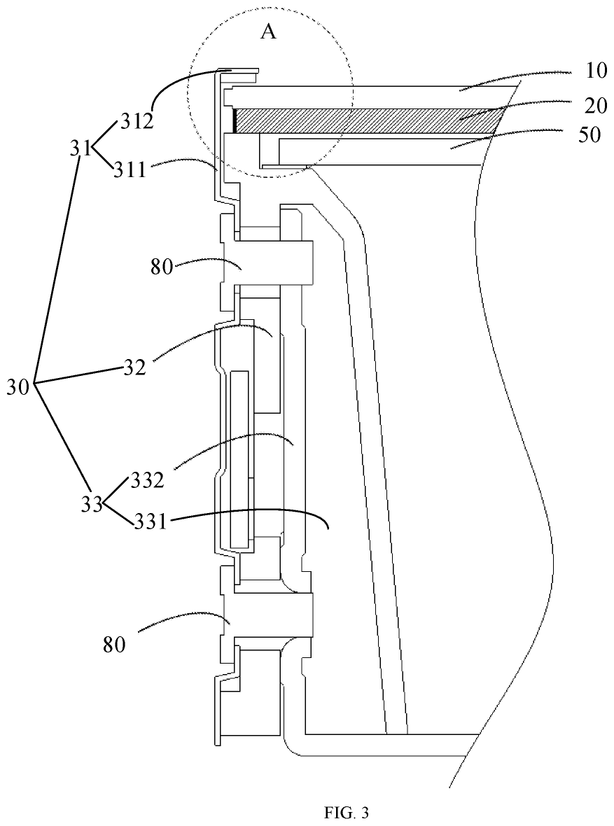

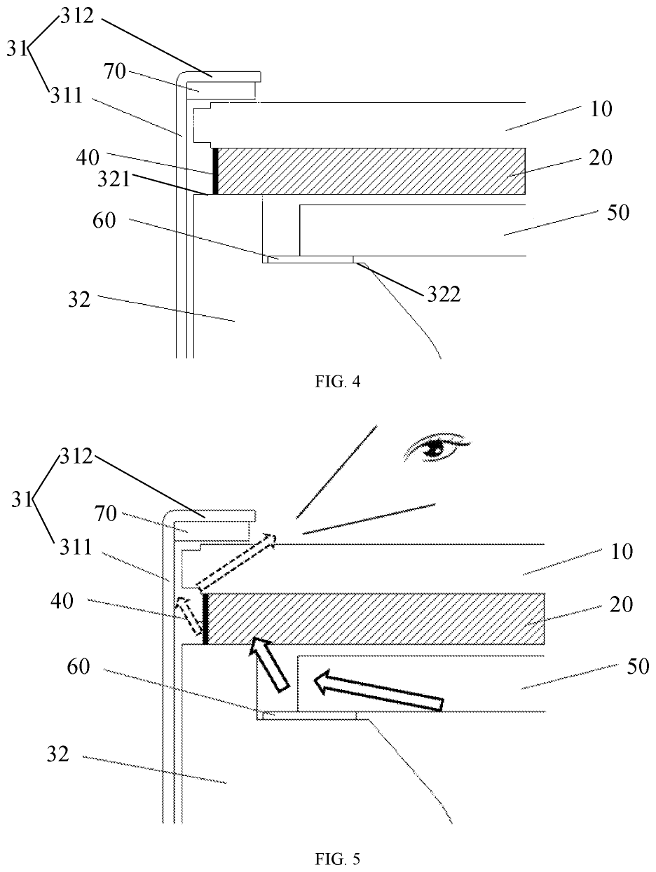

FIG. 3 is a schematic structural view of a display module according to an embodiment of the present disclosure, and FIG. 4 is an enlarged view of area A in FIG. 3. As shown in FIGS. 3 and 4, the display module includes a display panel 10, an optical film 20, a support assembly 30, and a light shielding structure 40. The support assembly 30 is configured to support the display panel 10 and the optical film 20, and the support assembly 30 wraps the side surface of the display panel 10 and the side surface of the optical film 20. The optical film 20 is disposed on the backlight side of the display panel 10. The light shielding structure 40 is disposed on the side surface of the optical film 20. The light shielding structure 40 can block the light and the light inside the optical film 20 may be prevented from being transmitted from the side surface of the optical film 20.

In the display module according to the embodiments of the present disclosure, the support assembly may support the display panel and the optical film, a light shielding structure is disposed on the side surface of the optical film, wherein the light shielding structure can block the light and the light inside the optical film may be prevented from being transmitted from the side surface of the optical film. In this way, the light is prevented from being transmitted through the gap between the display panel and the support assembly, and the bright edge of the display module is addressed. The embodiments of the present disclosure address the bright edge of the display module only by disposing a light shielding structure on the side surface of the optical film without disposing a thick foam between the bezel and the display panel, nor attaching a rubber ribbon inside the bezel, such that the cost of the display module is low and the display panel will not be pulled. In addition, in the display module, no light reflected by the side wall of the middle frame to the AA is present, such that the light reflected by the side wall of the middle frame to the AA can be avoided to affect the display effect of the AA.

FIG. 5 is a schematic diagram of a light path of the display module shown in FIG. 4 according to an embodiment of the present disclosure. As shown in FIG. 5, a backlight (not shown in FIG. 5) is disposed on a side, distal from the display panel 10, of the optical film 20. The light emitted from the backlight enters the display panel 10 through the optical film 20. The optical film 20 may diffuse the light emitted from the backlight, and the backlight and the optical film 20 may provide a surface light source with high luminance and high uniform for the display panel 10.

The optical film 20 may include a diffuser film, a reflective sheet, a luminance enhancing film, or the like. Both the diffuser film and the reflective sheet are configured to enhance the luminescence uniformity of the surface light source, and the luminance enhancing film is configured to increase the luminance of the light emitted from the backlight. The optical film 20 has a large enough thickness. In the case that no light shielding structure 40 is disposed on the side surface of the optical film 20, when the light emitted from the backlight passes through the optical film 20, a certain amount of light will be transmitted from the side surface of the optical film 20, and the light emitted from the backlight is transmitted out of the display module through the gap between the display panel 10 and the support assembly 30, resulting in the bright edge of the display module. In the embodiments of the present disclosure, the light shielding structure 40 is disposed on the side surface of the optical film 20, and the light shielding structure 40 may block the light, such that no light is transmitted from the side surface of the optical film 20, and no light is emitted from the display module through the gap between the display panel 10 and the support assembly 30. Therefore, the bright edge of the display module is addressed. The technical solutions according to the embodiments of the present disclosure applied to a display module with a large viewing angle are particularly effective, and the light leakage at the edge of a display module with a large viewing angle can be better solved. Moreover, since the light shielding structure 40 is disposed on the side surface of the optical film 20, even when the optical film 20 is deformed by thermal expansion, the position of the light shielding structure 40 is not affected, such that the light shielding structure 40 may not squeeze the support assembly 30, and a better effect is achieved.

In the embodiments of the present disclosure, the light shielding structure 40 includes at least one of: a light shielding film coated on a side surface of the optical film 20, and a light shielding block attached to a side surface of the optical film 20. In the case that the light shielding structure 40 includes a light shielding block attached to the side surface of the optical film 20, when manufacturing the display module, at first, the light shielding block may be attached to the side surface of the optical film 20, and then, the display panel 10 and the optical film 20 attached with the light shielding block are assembled together; or, at first, the display panel 10 and the optical film 20 are assembled together, and then, the light shielding block is attached to the side surface of the optical film 20. In the case that the light shielding structure 40 includes a light shielding film coated on the side surface of the optical film 20, when manufacturing the display module, first, the solution containing the light shielding solute is coated or printed on the side surface of the optical film 20, and then, the coated solution on the side surface of the optical film 20 is dried to remove the solvent, leaving the solute on the side surface of the optical film 20 to obtain the light shielding film. The light shielding structure 40 formed by coating is fixed to and in contact with the side surface of the optical film 20 tightly, which helps to improve the light shielding effect of the light shielding structure 40.

In some embodiments, the material of the light shielding structure 40 includes a black resin. The material of the light shielding structure 40 may also be a material with a specific light shielding function, such as an acrylic adhesive, which is not limited thereto.

In the embodiment of the present disclosure, the optical film 20 includes two film planes that are parallel to each other and two side surfaces that intersect with the two film planes. The side surface of the optical film 20 may include a target side surface and a non-target side surface. The target side surface of the optical film 20 is disposed on the bonding side of the display panel 10 (i.e., the target side surface of the optical film 20 is on the same side as the bonding side of the display panel 10). The non-target side surface of the optical film 20 is the side surface of the optical film 20 other than the target side surface. The light shielding structure 40 may be disposed on a non-target side surface of the optical film 20. Optionally, three non-target side surfaces may be present on the optical film 20, a light shielding structure 40 may be disposed on each of the three non-target side surfaces, and the light shielding structure 40 disposed on some of the non-target side surfaces is a light shielding block attached to the non-target side surface, the light shielding structure 40 disposed on the other non-target side surface is a light shielding film coated on the non-target side surface, or the light shielding structures 40 disposed on the three non-target side surfaces are all coated with the light shielding film.

In some embodiments of the present disclosure, the support assembly 30 includes a first support stage and a second support stage that are stepwise distributed.

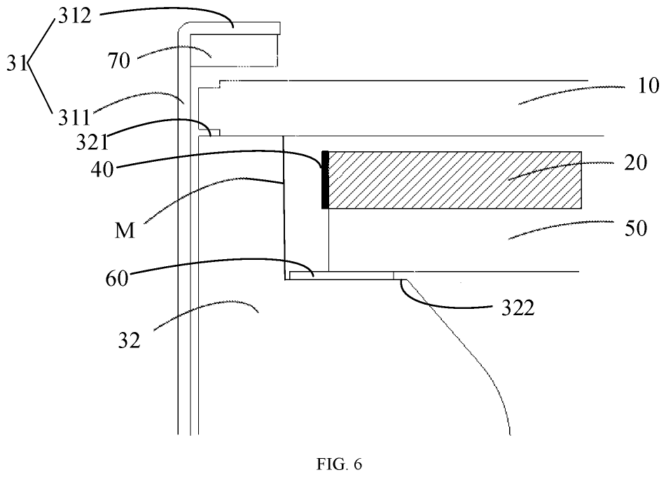

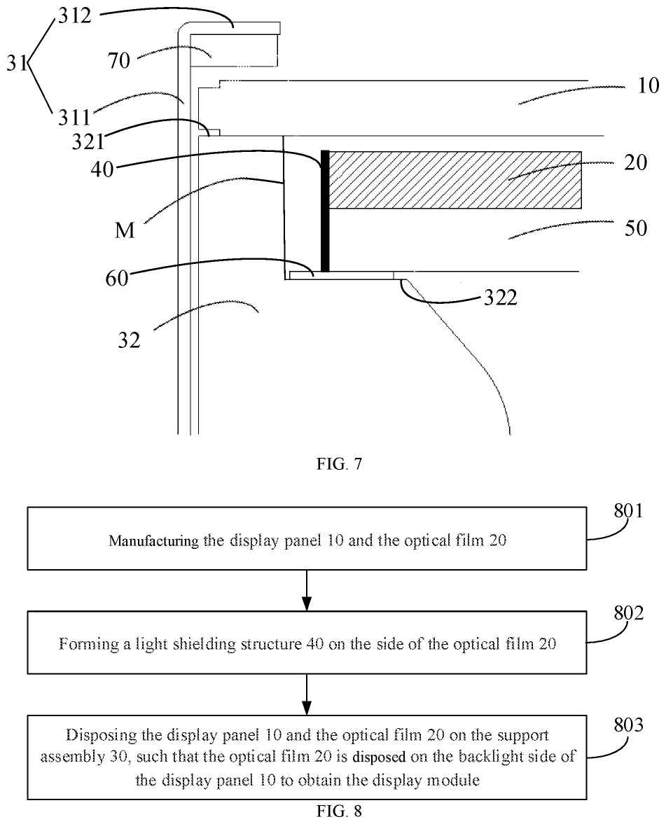

The height of the first support stage may be greater than the height of the second support stage, the support surface of the first support stage and the support surface of the second support stage may be parallel. With respect to the display panel 10, the optical film 20, the first support stage and the second support stage: both the display panel 10 and the optical film 20 are disposed on the first support stage; or the display panel 10 is disposed on the first support stage, and the optical film 20 is disposed on the second support stage. Exemplarily, as shown in FIG. 4, the support assembly 30 includes a first support stage 321 and a second support stage 322 that are stepwise distributed, and the display panel 10 and the optical film 20 are disposed on the first support stage 321. Further, exemplarily, as shown in FIGS. 6 and 7, the support assembly 30 includes a first support stage 321 and a second support stage 322 that are stepwise distributed, wherein the display panel 10 is disposed on the first support stage 321, and the optical film 20 is disposed on the second support stage 322.

As shown in FIGS. 4, 6, and 7, the display module also includes a diffuser plate 50, wherein the diffuser plate 50 is disposed on a side, distal from the display panel 10, of the optical film 20, and the diffuser plate 50 may be fixed to the second support stage 322 by a double-sided adhesive tape 60. With respect to the display module shown in FIG. 4, the optical film 20 may be attached to the first support stage 321 by a double-sided adhesive tape, the display panel 10 is overlapped on the optical film 20, the display panel 10 is disposed on the first support stage 321 by the support of the optical film 20, and the orthographic projection of the optical film 20 on the display surface of the display panel 10 may be disposed within the display surface of the display panel 10. With respect to the display module shown in FIGS. 6 and 7, the optical film 20 is overlapped on the diffuser plate 50, the optical film 20 is disposed on the second support stage 322 by the support of the diffuser plate 50, and the orthographic projection of the optical film 20 on the display surface of the display panel 10 may be coincident with the orthographic projection of the diffuser plate 50 on the display surface of the display panel 10. As shown in FIG. 7, the light shielding structure 40 extends to the side surface of the diffuser plate 50, such that the light shielding structure 40 can also prevent the light in the diffuser plate 50 from being transmitted from the side surface of the diffuser plate 50, further addressing the edge leakage and bright edge of the display module. In the case that the display module includes the diffuser plate 50, the backlight (neither shown in FIGS. 3 and 4) may be disposed on a side, distal from the display panel 10, of the diffuser plate 50 and the light emitted from the backlight passes through the diffuser plate 50 and the optical film 20 into the display panel 10.

As shown in FIGS. 3, 4, 6, and 7, the support assembly 30 includes a front frame 31 and a middle frame 32, wherein the middle frame 32 includes a first support stage 321 and a second support stage 322 (i.e., the first support stage 321 and the second support stage 322 are the structures in the middle frame 32). The front frame 31 includes a body portion 311 of the front frame and a bend portion 312 of the front frame connected to the body portion 311 of the front frame, wherein an extension direction of the body portion 311 of the front frame may be perpendicular to an extension direction of the bend portion 312 of the front frame, the body portion 311 of the front frame is disposed on the side surface of the display panel 10, the bend portion 312 of the front frame is disposed on the side of the display surface of the display panel 10, and the body portion 311 of the front frame is connected to the middle frame 32. A foam rubber layer 70 is disposed between the bend portion 312 of the front frame and the display panel 10, the foam rubber layer 70 can cushion the bend portion 312 of the front frame and the display panel 10, avoiding a rigid collision between the bend portion 312 of the front frame and the display panel 10 resulting in damage to the display panel 10. In the embodiments of the present disclosure, the free thickness of the foam rubber layer 70 is less than the predetermined thickness, and the free thickness of the foam rubber layer 70 is small, thereby reducing the material cost. The free thickness of the foam rubber layer 70 is the thickness of the foam rubber layer 70 in the uncompressed state, and the thickness direction of the foam rubber layer is perpendicular to the display surface of the display panel 10. Since the light shielding structure 40 is disposed on the side surface of the optical film 20, the light inside the optical film 20 may be prevented from being transmitted from the side surface of the optical film 20 by the light shielding structure 40. Therefore, this part of the light is prevented from entering the gap between the bend portion 312 of the front frame and the display panel 10. In this way, the free thickness of the foam rubber layer 70 may be set to be small, he foam rubber layer 70 only achieves a buffering effect.

As shown in FIG. 3, the support assembly 30 also includes a back plate 33. The back plate 33 includes a body portion 331 of the back plate and a bending portion 332 of the back plate connected to the body portion 331 of the back plate, wherein an extending direction of the bending portion 332 of the back plate may be perpendicular to an extending direction of the body portion 331 of the back plate. The body portion 331 of the back plate is disposed on a side, distal from the display panel 10, of the optical film 20, and the bend portion 332 of the back plate is disposed on a side, distal from the body portion 311 of the front frame, of the middle frame 32 and is connected to the middle frame 32. For example, the body portion 331 of the back plate is disposed on a side, distal from the display panel 10, of the diffuser plate 50. The height of either the first support stage 321 or the second support stage 322 is the distance between the support surface of the support stage and the reference plane, wherein the reference plane may be the plane on which the body portion 331 of the back plate is disposed.

In some embodiments, each of the front frame 31, the middle frame 32, and the back plate 33 is an integrally formed structure. For example, each of the front frame 31, the middle frame 32, and the back plate 33 may be a structure formed by an injection molding process.

The front frame 31, the middle frame 32, and the back plate 33 are fixedly connected. As shown in FIG. 3, the body portion 311 of the front frame, the middle frame 32, and the bend portion 332 of the back plate are fixedly connected by screws 80, such that the front frame 31, the middle frame 32, and the back plate 33 are fixedly connected to realize the assembly of the display module.

As shown in FIG. 4, in the case that the optical film 20 is disposed on the first support stage 321, since the light shielding structure 40 is disposed on the side surface of the optical film 20, the light inside the optical film 20 may be prevented from being transmitted from the side surface of the optical film 20 by the light shielding structure 40, such that this part of the light may be prevented from being emitted from the display module through the gap between the display panel 10 and the front frame 31 and the gap between the display panel 10 and the foam rubber layer 70, and thus the light leakage problem and bright edge of the display module are addressed. As shown in FIG. 6, the display panel 10 is disposed on the first support stage 321, and the optical film 20 is disposed on the second support stage 322, wherein the first support stage 321 includes a side wall M of the middle frame. Even when a light may be reflected by the side wall M of the middle frame, since the light shielding structure 40 is disposed on the side surface of the optical film 20, the light inside the optical film 20 may be prevented from being transmitted from the side surface of the optical film 20 by the light shielding structure 40, such that this part of the light may not be irradiated to the side wall M of the middle frame and may not be reflected to the AA of the display panel 10 by the side wall M of the middle frame, and thus the bright edge may be addressed on the AA edge of the display panel 10. As shown in FIG. 7, the display panel 10 is disposed on the first support stage 321, the optical film 20 and the diffuser plate 50 are both disposed on the second support stage 322, the light shielding structure 40 extends from the side surface of the optical film 20 to the side surface of the diffuser plate 50, and the first support stage 321 includes a side wall M of the middle frame. Even when a light may be reflected by the side wall M of the middle frame, since the light shielding structure 40 is disposed on the side surface of the optical film 20 and the side surface of the diffuser plate 50, the light inside the optical film 20 may be prevented from being transmitted from the side surface of the optical film 20 by the light shielding structure 40, and the light inside the diffuser plate 50 may be prevented from being transmitted from the side surface of the diffuser plate 50, such that this part of the light may not be irradiated to the side wall M of the middle frame, and may not be reflected by the side wall M of the middle frame to the AA of the display panel 10, and thus the bright edge may be addressed on the AA edge of the display panel 10.

In the embodiments described above, the display panel 10 includes a liquid crystal display panel, wherein the liquid crystal display panel may be a multi-screen liquid crystal display panel or the like. The display panel 10 may also be other types of the display panels.

In some embodiments, the above-mentioned display module is a splicing screen, wherein a splicing seam is present in the splicing screen, and the light shielding structure 40 is disposed on the side, distal from the splicing seam, of the splicing screen. The display module can be a splicing screen with a large viewing angle. By disposing the light shielding structure 40 on the side, distal from the splicing seam, of the splicing screen, no light leakage or no bright edge of the large viewing angle splicing screen occurs, thereby effectively improving the image quality.

A display module of the present disclosure has been described as above, and a method for manufacturing the display module is described below. The methods and principles for manufacturing the display modules in the embodiments herein may be referred to as descriptions in the embodiments below.

FIG. 8 is a flowchart of a method for manufacturing a display module according to an embodiment of the present disclosure. The method may be applicable to manufacturing a display module in the foregoing embodiments. As shown in FIG. 8, the method includes the following processes:

In 801, the display panel 10 and the optical film 20 are manufactured.

The display panel 10 may be a liquid crystal display panel, and the optical film 20 may include a diffuser film, a reflective sheet, a luminance enhancing film, and the like.

In some embodiments, manufacturing the optical film 20 may include manufacturing structures such as diffuser films, reflective sheets, and luminance enhancing films.

In 802, a light shielding structure 40 is formed on the side surface of the optical film 20.

In the embodiments of the present disclosure, the light shielding structure 40 formed on the side surface of the optical film 20 includes at least one of: a light shielding film coated on the side surface of the optical film 20, and a light shielding block attached to the side surface of the optical film 20.

In some embodiments, the solution containing the light shielding solute is coated on the side surface of the optical film 20, and then the solution coated on the side surface of the optical film 20 is dried to remove the solvent, such that the solute remains on the side surface of the optical film 20 to obtain a light shielding film.

In some embodiments, the light shielding block is attached to the side surface of the optical film 20 by a double-sided adhesive tape.

In 803, the display panel 10 and the optical film 20 are disposed on the support assembly 30, such that the optical film 20 is disposed on the backlight side of the display panel 10 to obtain the display module.

In the embodiments of the present disclosure, the support assembly 30 includes a first support stage 321 and a second support stage 322 that are stepwise distributed, wherein the height of the first support stage 321 may be greater than the height of the second support stage 322, and the support surface of the first support stage 321 may be parallel to the support surface of the second support stage 322. The display panel 10 and the optical film 20 are disposed on the support assembly 30, as illustrated in the following two examples.

In a first example, as shown in FIG. 4, the display panel 10 and the optical film 20 are disposed on the first support stage 321.

In some embodiments, first, the optical film 20 is fixed to the first support stage 321 by the double-sided adhesive tape, and then the display panel 10 is overlapped on the optical film 20, such that the display surface of the display panel 10 is distal from the optical film 20, and the edge region of the display panel 10 is fixed to the edge region of the optical film 20 by the double-sided adhesive tape.

In a second example, as shown in FIG. 6 or FIG. 7, the display panel 10 is disposed on the first support stage 321, and the optical film 20 is disposed on the second support stage 322.

In some embodiments, the display panel 10 is fixed to the first support stage 321 by the double-sided adhesive tape, and the optical film 20 is fixed to the second support stage 322 by the double-sided adhesive tape.

In some embodiments, the display module further includes a diffuser plate 50, and the method further includes the following processes.

In 804, a diffuser plate 50 is fabricated.

In 805, the diffuser plate 50 is disposed on the support assembly 30, such that the diffuser plate 50 is disposed on a side, distal from the display panel 10, of the optical film 20.

In some embodiments, the diffuser plate 50 is fixed to the second support stage 322 by the double-sided adhesive tape.

In some embodiments, for the second example in the step 803, first, the diffuser plate 50 is fixed to the second support stage 322 by the double-sided adhesive tape, and then the optical film 20 is overlapped on the diffuser plate 50, and the edge region of the optical film 20 is fixed to the edge region of the diffuser plate 50 by the double-sided adhesive tape.

In some embodiments, the support assembly 30 includes a front frame 31, a middle frame 32, and a back plate 33. Each of the front frame 31, the middle frame 32, and the back plate 33 is an integral molded structure, an injection molding process can be used to form the front frame 31, the middle frame 32, and the back plate 33, wherein the middle frame 32 includes a first support stage 321 and a second support stage 322. The front frame 31 includes a body portion 311 of the front frame and a bend portion 312 of the front frame connected to the body portion 311 of the front frame. The back plate 33 includes a body portion 331 of the back plate and a bend portion 332 of the back plate connected to the body portion of the back plate 331. After the display panel 10, the optical film 20 and the diffuser plate 50 are disposed on the support assembly 30, the body portion 311 of the front frame is disposed on the side of the display panel 10, the bend portion 312 of the front frame is disposed on the side of the display surface of the display panel 10, the body portion 311 of the back plate is disposed on a side, distal from the display panel 10, of the diffuser plate 50, the bend portion 322 of the back plate is disposed on a side, distal from the front frame body portion 311, of the middle frame 32, the front frame 31, the middle frame 32, and the back plate 33 cover a side, distal from the display panel 10, of the diffuser plate 50, the side surface of the diffuser plate 50, the side surface of the optical film 20, the side surface of the display panel 10, and the edge region of the display surface of the display panel 10, a foam rubber layer 70 is disposed between the bend portion 312 of the front frame and the display panel 10, and the body portion 311 of the front frame, the middle frame 32 and the bend portion 332 of the back plate are fixedly connected by screws 80.

In the display module manufactured by the method according to the embodiments of the present disclosure, the support assembly may support the display panel and the optical film, wherein a light shielding structure is disposed on the side surface of the optical film, and the light inside the optical film may be prevented from being transmitted from the side surface of the optical film by the light shielding structure, such that the transmission of light from the gap between the display panel and the support assembly us avoided, and the bright edge of the display module is addressed.

The embodiments of the present disclosure address the bright edge of the display module only by providing a light shielding structure on the side surface of the optical film without providing a thick foam between the bezel and the display panel, or attaching the tape inside the bezel, such that the cost of the display module is low and the display panel will not be pulled. In addition, in the display module, no light reflected by the side wall of the middle frame to the AA is present, such that the light reflected by the side wall of the middle frame to the AA can be prevented from affecting the display effect of the AA.

Embodiments of the present disclosure provide a display device that includes the display module described above. Exemplarily, the display device may be the products or the parts with a display function, such as an electronic paper, a cell phone, a tablet computer, a television, a display, a laptop computer, a digital photo frame, a navigator, a VR device, an augmented reality (AR) device, a wearable device, or the like.

It should be understood by those of ordinary skill in the art that described above are merely exemplary embodiments of the present disclosure, which are not intended to limit the scope of the application. The above embodiments, or technical features in different embodiments, may also be combined, steps may be implemented in any order, and many other variations of the various aspects of the embodiments of the present disclosure as described above are present, which are not provided in detail for the sake of brevity.

The embodiments of the present disclosure cover all such alterations, modifications, and variations that fall within the broad scope of the appended claims. Any omissions, modifications, equivalents, improvements, and the like, which can be made within the spirit and principles of the present disclosure, should be embraced within the protection scope of this disclosure.

What is claimed is:

1. A display module comprising:
a display panel;
an optical film, disposed on a backlight side of the display panel;
a support assembly, configured to support the display panel and the optical film; and
a light shielding structure, disposed on a side surface of the optical film.

2. The display module according to claim 1, wherein the light shielding structure comprises at least one of:
a light shielding film coated on the side surface of the optical film; and
a light shielding block attached to the side surface of the optical film.

3. The display module according to claim 1, wherein a material of the light shielding structure comprises a black resin.

4. The display module according to claim 1, wherein the side surface of the optical film comprises a target side surface and a non-target side surface, wherein the target side surface is disposed on a bonding side of the display panel, the non-target side surface is a side surface other than the target side surface, and the light shielding structure is disposed on the non-target side surface.

5. The display module according to claim 1, wherein the support assembly comprises a first support stage and a second support stage that are stepwise distributed;
wherein with respect to the display panel, the optical film, the first support stage, and the second support stage:
both the display panel and the optical film are disposed on the first support stage; or
the display panel is disposed on the first support stage and the optical film is disposed on the second support stage.

6. The display module according to claim 5, further comprising:
a diffuser plate, disposed on a side, distal from the display panel, of the optical film.

7. The display module according to claim 6, wherein the diffuser plate is fixed to the second support stage by a double-sided adhesive tape.

8. The display module according to claim 5, wherein the support assembly comprises: a front frame and a middle frame; wherein
the middle frame comprises the first support stage and the second support stage; and
the front frame comprises a body portion of the front frame and a bend portion of the front frame connected to the body portion of the front frame, wherein the body portion of the front frame is disposed on a side of the display panel, the bend portion of the front frame is disposed on a side of a display surface of the display panel, and the body portion of the front frame is connected to the middle frame.

9. The display module according to claim 8, wherein a foam rubber layer is disposed between the bend portion of the front frame and the display panel, wherein a free thickness of the foam rubber layer is less than a predetermined thickness, the free thickness of the foam rubber layer is a thickness of the foam rubber layer in an uncompressed state, and a thickness direction of the foam rubber layer is perpendicular to the display surface of the display panel.

10. The display module according to claim 9, the support assembly further comprising a back plate, wherein the back plate comprises a body portion of the back plate and a bend portion of the back plate connected to the body portion of the back plate, wherein the body portion of the back plate is disposed on a side, distal from the display panel, of the optical film, and the bend portion of the back plate is disposed on a side, distal from the body portion of the front frame, of the middle frame and is connected to the middle frame.

11. The display module according to claim 10, wherein each of the front frame, the middle frame, and the back plate is an integrally formed structure; and
the front frame, the middle frame, and the back plate are fixedly connected.

12. The display module according to claim 1, wherein the display panel comprises a liquid crystal display panel.

13. The display module according to claim 1, wherein the display module is a splicing screen, wherein a splicing seam is present in the splicing screen, and the light shielding structure is disposed on a side, distal from the splicing seam, of the splicing screen.

14. A method for manufacturing a display module, comprising:
manufacturing a display panel and an optical film;
forming a light shielding structure on a side surface of the optical film; and
disposing the display panel and the optical film on a support assembly, wherein the optical film is disposed on a backlight side of the display panel, such that the display module is obtained.

15. The method according to claim 14, wherein forming the light shielding structure on the side surface of the optical film comprises at least one of:
forming a light shielding film on the side surface of the optical film by coating; and
forming a light shielding block on the side surface of the optical film by attaching.

16. The method according to claim 14, wherein
the support assembly comprises a first support stage and a second support stage that are stepwise distributed; and
disposing the display panel and the optical film on the support assembly comprises:
disposing the display panel and the optical film on the first support stage; or
disposing the display panel on the first support stage and disposing the optical film on the second support stage.

17. The method according to claim 14, further comprising:
fabricating a diffuser plate; and
disposing the diffuser plate on the support assembly, such that the diffuser plate is disposed on a side, distal from the display panel, of the optical film.

18. The method according to claim 17, wherein disposing the diffuser plate on the support assembly comprises:
fixing the diffuser plate to the second support stage by a double-sided adhesive tape.

19. A display device comprising a display module, wherein the display module comprises:
a display panel;
an optical film, disposed on a backlight side of the display panel;
a support assembly, configured to support the display panel and the optical film; and
a light shielding structure, disposed on a side surface of the optical film.

20. The display device according to claim 19, wherein the light shielding structure comprises at least one of:
a light shielding film coated on the side surface of the optical film; and
a light shielding block attached to the side surface of the optical film.
